(19) United States
(12) Patent Application Publication
(10) Pub. No.: US 2005/0283616 A1
(43) Pub. Date: Dec. 22, 2005

(54) Interactive access control system and method for computer

(76) Inventor: Lai-Chen Lai, Yonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/125,235

(22) Filed: May 10, 2005

(30) Foreign Application Priority Data
Jun. 17, 2004 (TW) 93117453

(51) Int. Cl. H04K 1/00; H04L 9/00

(52) U.S. Cl. 713/182

(57) ABSTRACT

A system and method of interactive access control for a computer device is provided, applicable to an environment where a computer is shared by a plurality of users through user control units. The computer stores all the identification code, corresponding icons, and default access rights setting of all the user control units. When the computer detects a user requests for access to the computer, the computer displays the corresponding icon as a cursor on the monitor and allows the user to access the computer under the default access rights setting, all according to the identification code of the requesting user control unit.

### FIELD OF THE INVENTION

The present invention relates to a control technique for computers and, more particularly, to a control system and method of interactive accesses to a computer for managing and controlling a plurality of users to access a shared computer system.

### BACKGROUND OF THE INVENTION

Conventionally, a personal computer (PC) is designed for exclusive use by a single user. That is, only a user can access the computer at a time. However, as the network technologies progress, each individual computer can be linked through either a network interface or a server system to share and manage resources. Computer users are allowed to access data on other computers through the network authorization.

Although computers can share resources through a network interface at present, the interactivity is rather limited. Many applications, where interactivity plays an important role, are still constrained and cannot fully be exploited.

For example, the current business or academic presentation usually involves the use of a computer with a projector so that the contents of the presentation can be easily displayed on a screen. However, this method of display does not provide the attendees with sufficient interactivity. This is because the control of the display is solely in the hand of the presenter in this example. When a question is raised by an attendee regarding the contents of the displayed presentation, it is always difficult to locate the exact slide, especially when the Q&A session is held at the end of the presentation. It will be a convenient tool for presentation if the attendee can control the display to locate the slide when asking a question regarding a specific slide.

It is difficult to achieve such convenience of interactivity with the conventional computer system structure. Although the conventional computer system structure provides certain interactivity, resources sharing and access control through the LAN, it is impractical to install a computer with a specific set of application programs and establish required communication protocols. Therefore, it is imperative to find a cost-effective solution to provide the interactivity often required in business or academic presentations.

### SUMMARY OF THE INVENTION

The present invention is provided to solve the aforementioned problems found in the conventional computer systems. A primary objective of the present invention is to provide an access control system of a computer device, so that a single computer can be shared by a plurality of users for accessing functions and resources of that computer.

Another objective of the present invention is to provide an interactive access control method of a computer device. The users can interactively share a computer effectively.

To achieve these objectives, an access control system in accordance with the present invention comprises a user control unit for each user in an environment where a single computer shared by a plurality of user. The user control unit is equipped with an access request button and has a default identification number. When an access request button on a user control unit is actuated, the user control unit sends an access request signal to the computer for permission to access. Once the permission is granted and the connection is established, a cursor associated with the requesting user control unit appears on a display monitor associated with the computer. The cursor associated with the user control unit has a different appearance from the computer's own cursor, and has default control rights. To release the access, the user simply depresses the same access request button on the user control unit again to deactivate the granted access.

The user control units can be connected to the computer through cable network interface or wireless network interface. The user control unit can be in the shape of a control pen or a mouse to enable ease of use.

In comparison with the conventional methods, the present invention provides an interactive method to enable a plurality of users to selectively gain control of the same computer through various user control devices, such as mouse or control pen. Once the interactive mode is activated, the users are allowed to access the computer with the default access rights set by the computer or the administrator of the computer. Therefore, a plurality of users can interactively share a computer with default access rights. The present invention is applicable in an environment where a single computer is shared by a plurality of users in an interactive manner.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of an interactive access control method of the present invention applied in a computer system environment;

FIG. 2 shows a schematic view of the connection of a first embodiment of the present invention;

FIG. 3 shows a functional block diagram of the circuit of the present invention;

FIG. 4 shows a user control unit management table consisting of control unit identification (P_ID), icon type (Icon_Type), and use access rights setting (PWR_Level) according to the present invention;

FIG. 5 shows a flowchart of the operation of the present invention; and

FIG. 6 shows a schematic view of the connection of a second embodiment in accordance with the present invention.

### DETAILED DESCRIPTION OF THE PREFERRED EMBODIMENT

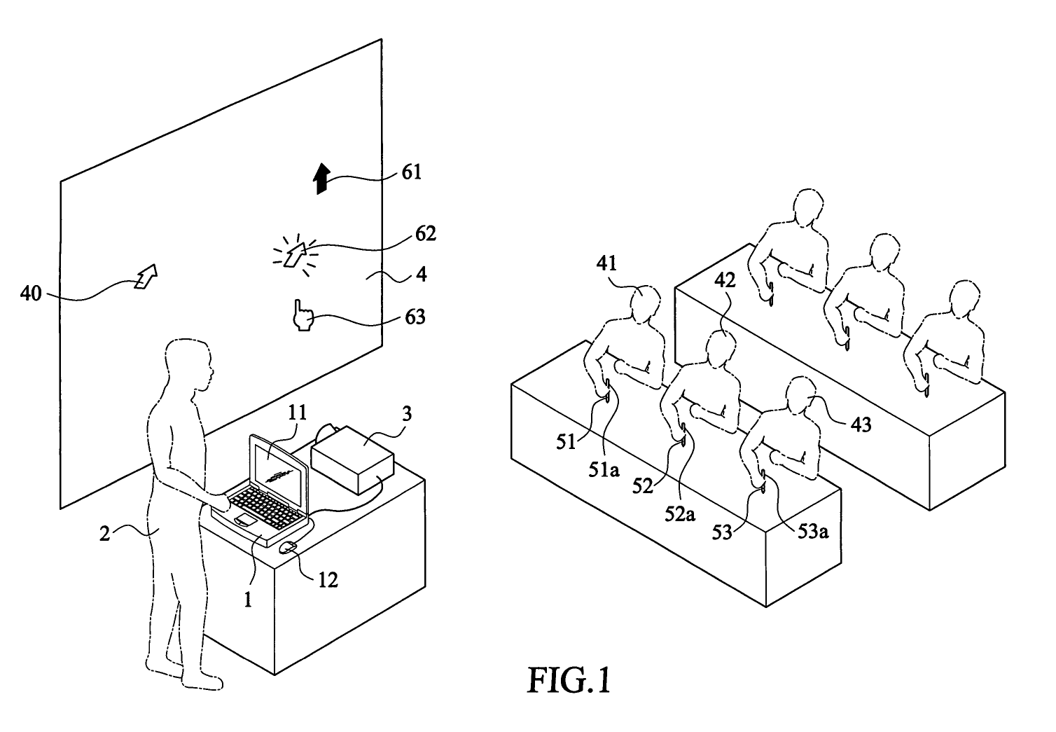

With reference to the drawings and in particular to FIG. 1, a computer 1 equipped with an interactive access control is placed on a main table. A main user 2 monitors and controls the operation of the computer 1 through a monitor 11. The computer 1 is connected with a mouse 12 to allow the main user 2 to control a cursor on the monitor 11 and control the operation of the computer 1.

Images displayed on the monitor 11 of the computer 1 can be projected to an enlarged screen 4 by a projector 3. Similarly, a cursor shown on the monitor 11 can also be projected as an enlarged cursor 40 on the screen 4. The enlarged cursor 40 indicates the location of the mouse 12 on the monitor 11, and the location of the cursor 40 is controlled by the mouse 12.

A plurality of users 41, 42, 43 are sitting close to the screen 4, with each user 41, 42, 43 provided with a user control unit 51, 52, 53. Each user control unit 51, 52, 53 includes an access request button 51a, 52a, 53a, respectively.

For applications, such as presentation, when a user 41, 42, 43 actuates the access request button 51a, 52a, 53a on the user control unit 51, 52, 53, the user control unit 51, 52, 53 generates a request signal to the computer 1 for permission to access the computer 1. Once the request is granted and the connection is established, an icon type 61, 62, 63 appears on the enlarged screen 4. The icon type 61, 62, 63 has a different appearance from the original computer cursor 40 and is also different from each other by for example variations in shape, color or blinking, and has a set of default access rights.

Each user control unit 51, 52, 53 has a default identification code (P_ID). This allows a plurality of users, such as users 41, 42, 43, under the default access rights, to interactively access the computer 1. The user may deactivate the access rights when finishing accessing the computer 1 by for example making actuation of the access request button 51a, 52a, 53a again. Alternatively, a deactivation button (not shown) can be provided.

The present invention provides interactivity through various types of user control units, such as mouse or control pen, and allows a plurality of users to access the same computer. Once the interactive mode is activated, the user can control, under the default access rights, part of the operations of the computer. The default access rights can be configured by the main user or the administrator of the computer.

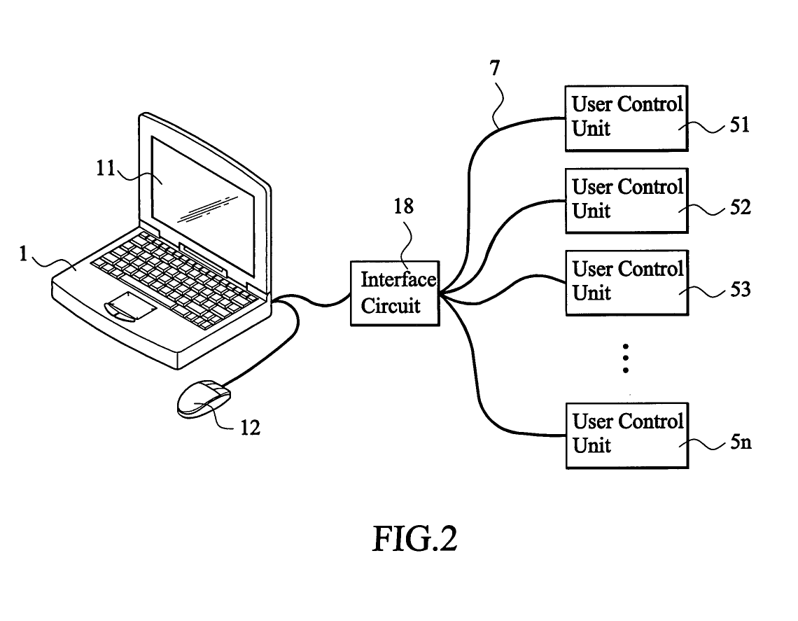

FIG. 2 shows a schematic view of the connection of the system in accordance with the first embodiment of the present invention. The computer 1 is connected to a plurality of user control units 51, 52, 53 . . . 5n through an interface circuit 18 and cables 7. When the access request button 51a, 52a, 53a of the user control unit 51, 52, 53 is actuated, the request signal is transmitted to the computer 1 through the cable 7.

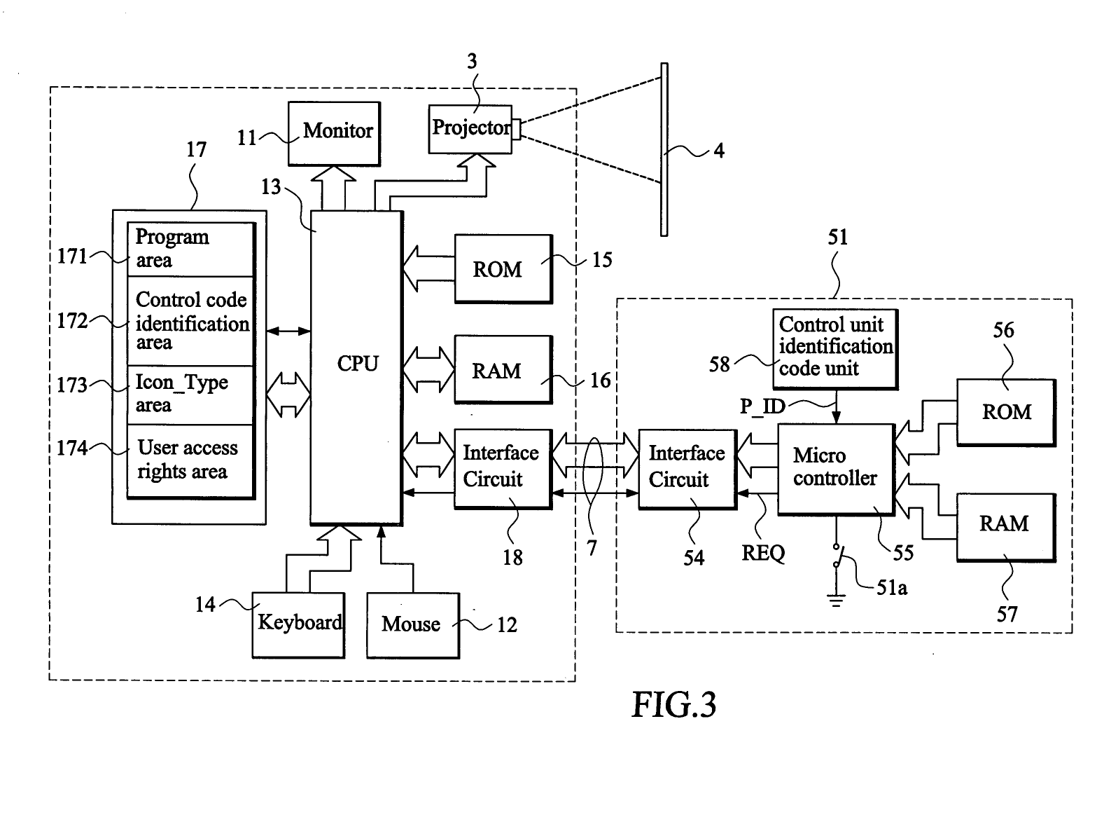

FIG. 3 shows a functional block diagram of a control circuit of the present invention. The computer 1 includes a central processing unit (CPU) 13, which is connected to a mouse 12 and a keyboard 14 for input. The text and the images generated by the computer 1 is displayed on a monitor 11, and is also transmitted to a projector 3 through a projector interface 31 for projection onto the enlarged screen 4.

The CPU 13 is connected to a read-only-memory (ROM) 15, a random-access-memory (RAM) 16, and data storage (such as hard disk drive) 17. The data storage 17 includes a program area 171 for storing an interactive access control program of the present invention. Through the activation of the program area 171, the operation in the interactive mode of the present invention can be executed.

The data storage 17 also includes a control code identification area 172 for storing a plurality of identification codes (P_IDs).

The data storage 17 further includes an Icon_Type area 173 for storing a plurality of icon types. The icon types are used as different types of cursor to distinguish different users, such as users 41, 42, 43. The icon types can be different in shapes, color or blinking for easy differentiation.

The data storage 17 further includes a user access rights area 174 for storing the default access rights PWR_Level configured by main user 2 of the computer 1.

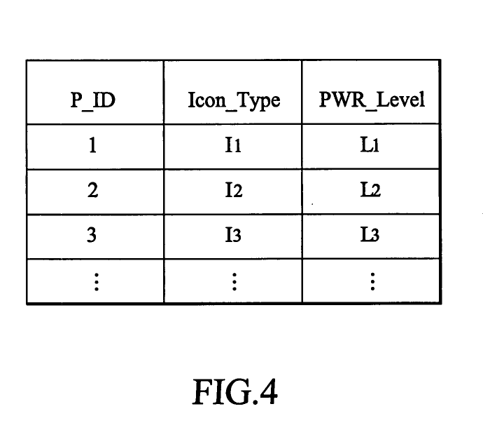

The aforementioned identification code (P_ID), Icon_Type, and PWR_Level constitute a user control management table, as shown in FIG. 4. Based on the management table, the computer 1 can easily identify the user control units, such as the user control units 51, 52, 53, and displays an appropriate icon type as well as manage the access level of the user 41, 42, 43.

As shown in FIG. 3, the CPU 13 of the computer 1 is connected to a user control unit, such as the user control unit 51, through an interface circuit 18 and a cable 7. Only a single user control unit 51 is shown in FIG. 3, while the other user control units are omitted, and can be connected to the computer 1 using the same method.

The user control unit 51 comprises an interface circuit 54, connected to the interface circuit 18 of the computer 1 through the cable 7. A micro controller 55 is connected to the computer 1 through the interface circuit 54. The user control unit 51 also comprises a ROM 56 and a RAM 57 respectively connected to the micro controller 55.

When the access request button 51a of the user control unit 51 is actuated, the micro controller 55 issues a request signal (REQ), which is transmitted through the interface circuit 54 and the cable 7 to the computer 1 for request of permission for accessing the computer 1.

The micro controller 55 is further connected to a control unit identification code unit 58 for storing and providing the identification code (P_ID) to the micro controller 55. The identification code (P_ID) indicates the specific identification code of the user control unit 51, and matches a P_ID stored in the P_ID area 172 of the data storage 17. Therefore, the computer 1 identifies the user control unit 51 issuing the request (REQ) based on the identification code (P_ID).

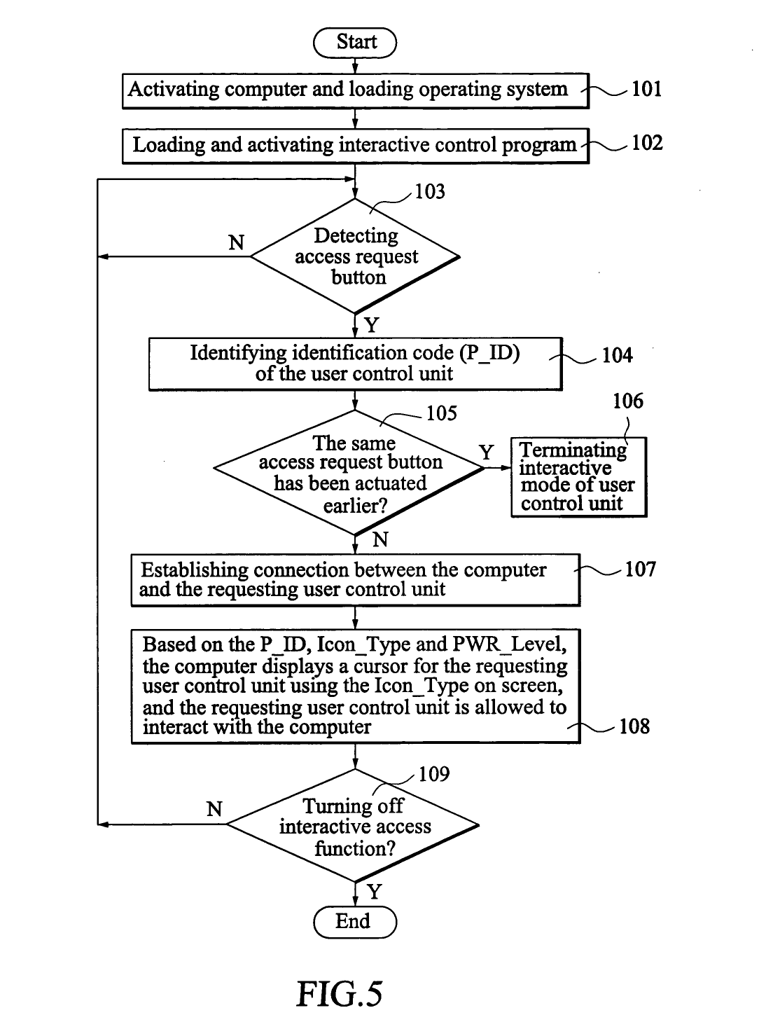

FIG. 5 shows a flowchart of an operation method in accordance with the present invention. In the method of the present invention, the computer 1 is first activated and the operating system is loaded in the computer 1, step 101. In the next step, step 102, the interactive control program stored in the program area 171 of the data storage 17 is loaded into the computer 1 and then activated.

When the computer 1 detects an access request button is pressed, step 103, the interactive control program identifies the identification code (P_ID) of the user control unit, step 104, and then determines whether the same access request button has been actuated earlier, step 105. If the same button has been pressed earlier, it indicates the user requests a release (deactivation) of the access to the computer 1. As a result of the second actuation of the access request button, the computer 1 terminates the interactive mode of the user control unit, step 106.

On the other hand, if the access request button has not been pressed earlier in step 105, the computer 1 establishes a connection with the requesting user control unit, step 107. Based on the P_ID, Icon_Type and PWR_Level of FIG. 4, the computer 1 displays a cursor 61 for the requesting user control unit 51 using the Icon_Type on screen 4. At this point, the user of the user control unit 51 is allowed to interact with the computer 1 with the default access right setting.

When the interactive access function is turned off (step 109), no user control unit 51 can access the computer 1.

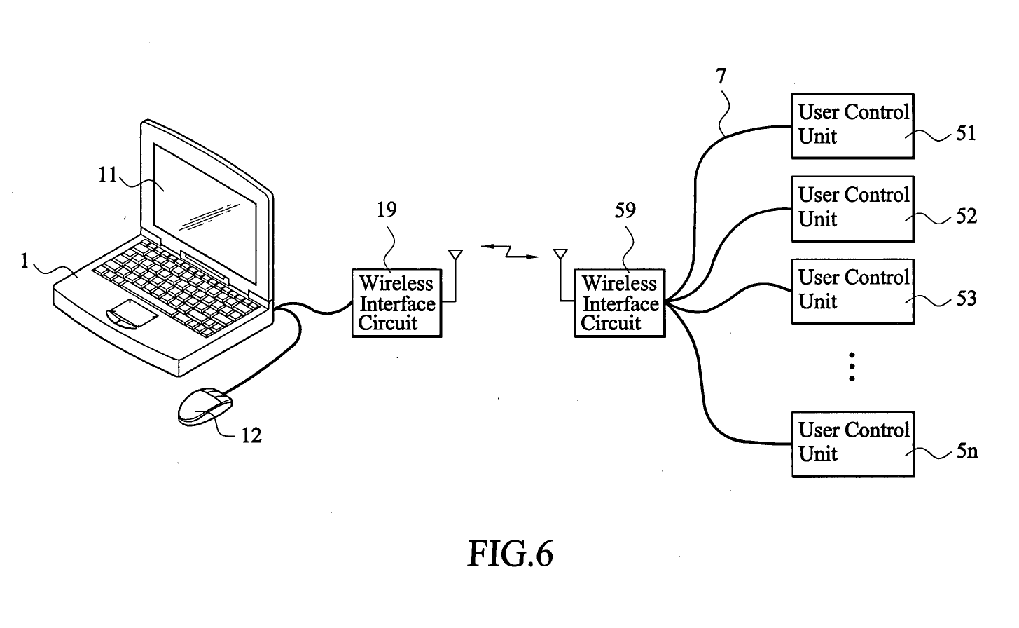

The aforementioned embodiment uses a cable for connection. Alternatively, various wireless communication technologies, such as Bluetooth, RF, infrared, can also be used to accomplish the same connection function. FIG. 6 shows a schematic view of the connection of the system in accordance with a second embodiment of the present invention. As shown in FIG. 6, the computer 1 is connected to a wireless interface circuit 19. The user control unit 51, 52, 53 is also connected to a wireless interface circuit 59. Through the wireless communication between wireless interface circuit 19 and wireless interface circuit 59, the connection as in the first embodiment can be accomplished between the computer 1 and the user control unit 51, 52, 53.

While the invention has been described in connection with what is presently considered to the most practical and preferred embodiments, it is to be understood that the invention is not to be limited to the disclosed embodiment, but on the contrary, is intended to cover various modifications and equivalent arrangement included within the spirit and scope of the appended claims.

1. An interactive access control system of a computer, comprising:
a computer comprising a monitor displaying a cursor of the computer, the computer comprising a control unit identification code area for storing a plurality of control unit identification codes each corresponding to a user control unit, and an icon type area for storing an icon type for each user control unit;
each user control unit comprising an access request button, which, when actuated, issues a request signal to the computer to obtain access to the computer; and
an interface circuit connecting the user control unit to the computer;
where when the computer receives the request signal from a selected one of the user control units through the respective interface circuit, the computer displaying the respective icon on the monitor based on the respective control unit identification code, and allowing the user control unit to access the computer.

2. The system as claimed in claim 1, wherein the user control unit comprises a pen shaped device.

3. The system as claimed in claim 1, wherein a default set of access rights are set for each user control unit, under which the user control unit performs accesses of the computer.

4. The system as claimed in claim 1, wherein the interface circuit comprises a wireless interface circuit.

5. The system as claimed in claim 1, wherein the interface circuit comprises a cable interface circuit.

6. An interactive access control system of a computer, comprising:
a computer comprising a monitor displaying a cursor of the computer, the computer comprising a control unit identification code area for storing a plurality of control unit identification codes each corresponding to a use control unit, and an icon type area for storing an icon type for each user control unit;
a projection device connected to the computer for projecting images generated by the computer;
an enlarged screen located at projection direction of the projection device for displaying the images and the cursor of the computer;
each user control unit comprising an access request button, which when actuated, issues a request signal to the computer to obtain access to the computer; and
an interface circuit connecting the user control unit to the computer;
where when the computer receives the request signal from a selected one of the user control unit through the respective interface circuit, the computer displaying the respective icon on the monitor and the enlarged screen based on the respective control unit identification code, and allowing the user control unit to access the computer.

7. The system as claimed in claim 6, wherein the user control unit comprises a pen shaped device.

8. The system as claimed in claim 6, wherein a default set of access rights are set for each user control unit, under which the user control unit performs accesses of the computer.

9. The system as claimed in claim 6, wherein the interface circuit comprises a wireless interface circuit.

10. The system as claimed in claim 6, wherein the interface circuit comprises a cable interface circuit.

11. A method for interactive access control of a computer, applicable to an environment comprising a computer and a plurality of user control units for managing and controlling accesses to the computer through the user control units; the method comprising the steps of:
(a) activating the computer, and loading operating system and interactive access control program into the computer;
(b) the computer being pre-stored with a control unit identification code and an corresponding icon associated with each user control unit;
(c) the computer detecting whether an access request signal being issued by a specific one of the user control units; and
(d) the computer receiving the request signal from the specific user control unit and displaying the respective icon associated with the specific user control unit on a monitor based on the respective identification code, and allowing the user control unit to access the computer.

12. The method as claimed in claim 11, wherein the user control unit comprises an access request button, which when actuated, issuing the access request signal to the computer.

13. The method as claimed in claim 11, wherein a default set of access rights are set for each user control unit in the computer, and the user control unit only accesses the computer under the default access rights setting.

14. The method as claimed in claim 11, wherein step (d) further comprises a step to determine whether the user control unit has issued an access request signal earlier; if so, the computer releases the access from the user control unit.
